(19) United States
(12) Patent Application Publication
(10) Pub. No.: US 2002/0161913 A1
(43) Pub. Date: Oct. 31, 2002

(54) System and method for performing a download

(76) Inventors: Manuel Gonzalez, Barcelona (ES); Luca Chiarabini, San Diego, CA (US)

Correspondence Address: HEWLETT-PACKARD COMPANY, Intellectual Property Administration, P.O. Box 272400, Fort Collins, CO, 80527-2400, US

(21) Appl. No.: 09/843,931

(22) Filed: Apr. 30, 2001

(51) Int. Cl. G06F 15/16

(52) U.S. Cl. 709/233

(57) ABSTRACT

A system and method is disclosed for downloading information from a remote device during a scheduled period of time and when a data transfer rate is greater than a predetermined threshold. A plurality of clients are connected to a server through a network. The server schedules a period of time for each client to download information from the server. At a scheduled period of time for a client, the client measures a data transfer rate for a connection to the server prior to downloading information from the server. If the data transfer rate is not greater than the threshold, the download is not performed. The data transfer rate may be re-measured by the client during the scheduled period of time, and the download may be performed when the data transfer rate is greater than the threshold. Also, the download may be terminated if the data transfer rate falls below the threshold during the download.

### FIELD OF THE INVENTION

This invention relates generally to transferring information over a computer network. More particularly, the present invention is related to a download algorithm for downloading information over a computer network.

### BACKGROUND OF THE INVENTION

The Internet has provided users with access to a significant quantity of information. Accordingly, it is not uncommon for users to download large files requiring significant bandwidth, such as image files, applications, music files and the like, over the Internet. The amount of data which can be transmitted over the Internet is, however, limited by the Internet bandwidth.

When a user downloads a file from the Internet, the download is typically initiated at the same moment the download request is submitted (i.e., real time). If there are problems in downloading, then the download operation is halted and a new download request is submitted. Should the download problems persist, the user is typically given the option of continuing the download attempts or canceling the download altogether.

Real-time downloading suffers from a variety of drawbacks and difficulties. One such drawback is that failed download attempts may waste valuable machine resources, and the client may ultimately be unable to download needed information. Also, the user may start a download from a server when the server is busy, and the server may not have a mechanism to avoid performing the download.

Often, limited bandwidth may prevent a client from downloading information, especially when the client is attempting to download large files. Accordingly, several techniques have been developed for managing bandwidth for transferring information over a network.

Lambert et al., in U.S. Pat. No. 6,038,601, discloses a bandwidth management technique for transferring data, such as documents, over a network using transmission control protocol (TCP). In Lambert et al., a sender transmits data to a destination endpoint in a TCP “window”. The size of the window is adjusted according to the priority of the data being transmitted. High priority data requests are assigned larger windows and may be transmitted prior to low priority requests.

Krishnan, in U.S. Pat. No. 5,799,002, discloses a bandwidth throttling system for transmitting data over a network. In Krishnan, a server receives requests, such as a request for data, from clients. The server monitors the network bandwidth and compares the bandwidth to one or more thresholds when a request is received. If a threshold is exceeded, e.g., the available network bandwidth is below a predetermined value, the request may be delayed or blocked.

Both Lambert et al. and Krishnan disclose techniques for managing bandwidth for transmitting data over a network. However, Lambert et al. and Krishnan generally attempt to respond to requests in real time. Accordingly, Lambert et al. and Krishnan may not take advantage of increased bandwidth that may be available at an instance when it is known that network usage is generally low. Therefore, the techniques of Lambert et al. and Krishnan may not be optimal for transmitting large files over a network, because large files may be continually delayed or blocked.

### SUMMARY OF THE INVENTION

The present invention facilitates an improved system and method for downloading information.

In one respect, the present invention provides a method for transmitting information from a first device to a second device. The method includes steps of comparing a data transfer rate to a predetermined threshold; transmitting information from the first device during a scheduled period of time in response to the data transfer rate exceeding the predetermined threshold; and preventing a transmission of the information at a beginning of the scheduled period of time in response to the data transfer rate not exceeding the predetermined threshold. The data transfer rate is related to the average number of bits per unit time transmitted on a network connection between the first and second device.

The step of comparing a data transfer rate to a predetermined threshold may further include steps of determining whether a retry period of time has ended in response to the data transfer rate being below the predetermined threshold; canceling the scheduled transmission of information in response to the retry period of time ending; and determining whether a proximate end to the scheduled period of time has occurred in response to the retry period of time not ending (e.g., the proximate end being an instance in time prior to an end of the scheduled period of time).

The step of comparing a data transfer rate to a predetermined threshold may further include steps of canceling the scheduled transmission of information in response to an occurrence of the proximate end; and comparing a re-measured data transfer rate to the predetermined threshold in response to the proximate end to the scheduled transmission of information not occurring. Information may then be transmitted from the first device during the scheduled period of time in response to the re-measured data transfer rate exceeding the predetermined threshold.

The step of transmitting information from the remote device may also include comparing a data transfer rate of the information being transmitted to the predetermined threshold; and terminating the transmission in response to the data transfer rate being below the threshold. When the transmission is terminated during the transmission, steps for restarting the transmission, based on the steps described above and associated with the retry period and the proximate end, may be performed.

The method of the present invention includes steps that may be performed by computer-executable instructions recorded on a computer-readable medium.

In another respect, the present invention provides a system including a first device and a second device connected to the first device through a network. The first device is operable to transmit information to the second device at a scheduled period of time when a data transfer rate for a network connection between the first device and the second device exceeds a predetermined threshold.

In another respect, the present invention includes a network node connected to a network. The network node is operable to transmit information at a scheduled period of time on a communication path in the network when a data transfer rate for the communication path exceeds a predetermined threshold. The network is further operable to perform the following: prevent transmission of the information in response to the data transfer rate not exceeding the predetermined threshold; determine whether a retry period of time has ended in response to the data transfer rate being below the predetermined threshold; cancel the transmission of information during the scheduled period of time in response to the retry period of time ending; and compare a re-measured data transfer rate to the predetermined threshold in response to the retry period of time not ending.

In comparison to known prior art, the present invention may be capable of increasing the success of completing a download by scheduling a download when network usage may be low. Also, for improving the speed of downloading information, the present invention may perform a download when a data transfer rate is reasonable.

### BRIEF DESCRIPTION OF THE DRAWINGS

The present invention is illustrated by way of example and not limitation in the accompanying figures in which like numeral references refer to like elements, and wherein:

FIG. 1 illustrates a schematic block diagram of a typical system employing the principles of the present invention; and

FIG. 2 illustrates a flow diagram of an exemplary method employing the principles of the present invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

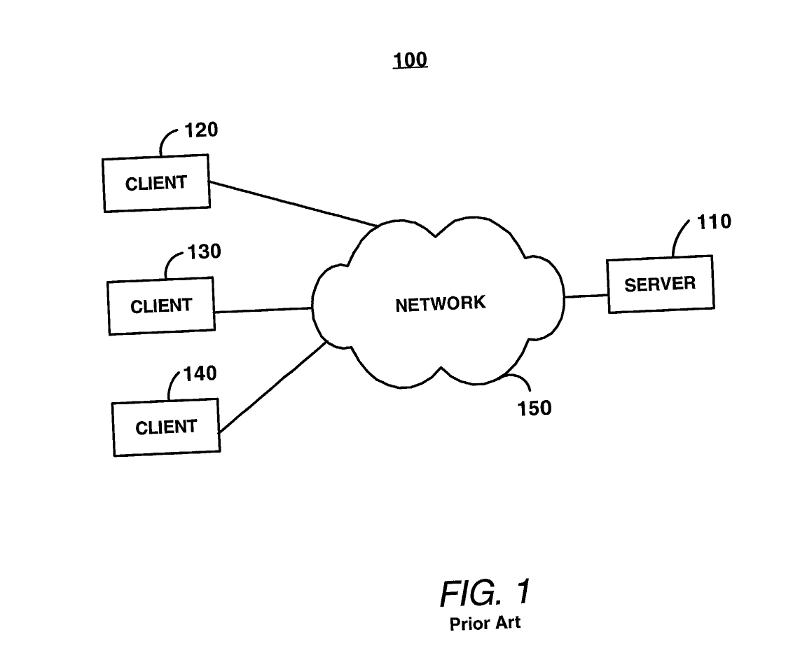

FIG. 1. illustrates an exemplary embodiment of system 100 employing the principles of the present invention. System 100 includes a server 110 connected to multiple clients 120-140 via a network 150. Network 150 may include one or more known networks, such as the Internet, intranet, local area network (LAN), wide area network (WAN), synchronous optical network (SONET), wireless network and the like. Server 110 may include a conventional network device (e.g., workstation, mainframe and the like) operable to perform functions (e.g., storing and retrieving data, file management and the like) of a server in a typical client-server relationship. Clients 120-140 may include conventional network devices (e.g., personal computers, laptops, servers, work stations, personal digital assistants, Internet-compatible wireless devices, set-top boxes and the like) operable to function as a client and make requests over network 150 to server 110. Communication between clients 120-140 and server 110 may be implemented over network 150 using a conventional protocol, such as transmission control protocol/Internet protocol (TCP/IP) and the like. Although three clients 120-140 and one server 110 are shown in FIG. 1, it will be apparent to one of ordinary skill in the art that the number of servers and clients in system 100 may be increased or decreased.

Server 110 may receive typical requests for network services (e.g., read requests, write requests, file management requests and the like) from clients 120-140 and may perform the requested network service. One such request may include a request (e.g., a read request) for a file. For example, each of clients 120-140 may request files from server 110. Instead of responding to requests in real-time, server 110 schedules a period of time for a client to download one or more files in response to a request. Periods of time to perform downloads may be scheduled when a connection between the server 110 and client 120 is established or prior to establishing the connection (e.g., at predetermined times). Then, server 110 notifies the client when a download should be attempted. For example, server 110 assigns a first period of time from 00:00 to 04:00 to client 120, a second period of time from 06:00 to 08:00 to client 130 and a third period of time from 18:00 to 21:00 to client 140 for downloading file(s) from server 110. The length of the scheduled period of time may vary depending on the size and number of requested files. By scheduling downloading times, the server may determine the optimal period of time for downloading files, especially large files consuming large amounts of bandwidth. For example, server 110 may determine that network usage for network 150 is low during a certain period of the day. Therefore, network 150 may attempt to schedule downloads for that period of the day. Accordingly, the downloads are less likely to be interrupted for lack of bandwidth.

Each client 120-140 may test the data transfer rate of their connection with server 110. For example, client 120 may be scheduled by server 110 to download one or more files from server 110 from 00:00 to 04:00. At 00:00, client 120 tests the data transfer rate of a connection with server 110 via network 150. If the data transfer rate is not greater than a predetermined threshold, the download may be delayed or blocked. Also, if the download is started, the data transfer rate is tested during the download. If the data transfer rate falls below the predetermined threshold during the download, the download may be terminated by client 120 and then attempted again or blocked.

The data transfer rate is related to the average number of bits per unit time transmitted on a network connection between server 110 and client 120. In general, the greater the bandwidth of a given connection, the higher the data transfer rate. The data rate may be measured in bits per second.

Testing the data transfer rate and terminating the download may be performed by the client. For example, during the download, the data transfer rate may be measured as the data is received. The number of bits received may be counted in a predetermined period of time. The data transfer rate, for example, is measured in bits per second. Prior to the download, the data transfer rate may be measured using known techniques. For example, server 110 may transmit a plurality of test packets to client 120. Client 120 may then measure the data transfer rate of the received test packets from server 110. Server 110 may also measure the data transfer rate of the connection with client 120. For example, server 110, using the Internet Control Message Protocol (ICMP), sends one or more ICMP packets to client 120 and waits for a response from client 120 (i.e., ICMP packets returned to server 110 from client 120). The data transfer rate is measured based on the data transfer rate of the ICMP packets.

The data transfer rate may be compared to a predetermined threshold by client 120. The predetermined threshold, for example, may be determined, such that a reasonable data transfer rate is established and maintained during the download. When a reasonable data transfer rate is not achieved for a download, the client may be utilizing limited resources to receive a file for an extended period of time. It will be apparent to one of ordinary skill in the art that the predetermined threshold may be determined based on a plurality of factors (e.g., network configuration, average size of files downloaded, average network congestion and the like) to allow files to be downloaded in a reasonable period of time.

As described above in an exemplary embodiment, system 100 includes client 120 that may measure the data transfer rate and terminate a download if the data transfer rate falls below a predetermined threshold. In another exemplary embodiment, server 120 may measure the data transfer rate of the connection between server 110 and client 120 using known techniques. For this embodiment, server 110 may delay, block and/or terminate a download if the data transfer rate falls below a predetermined threshold.

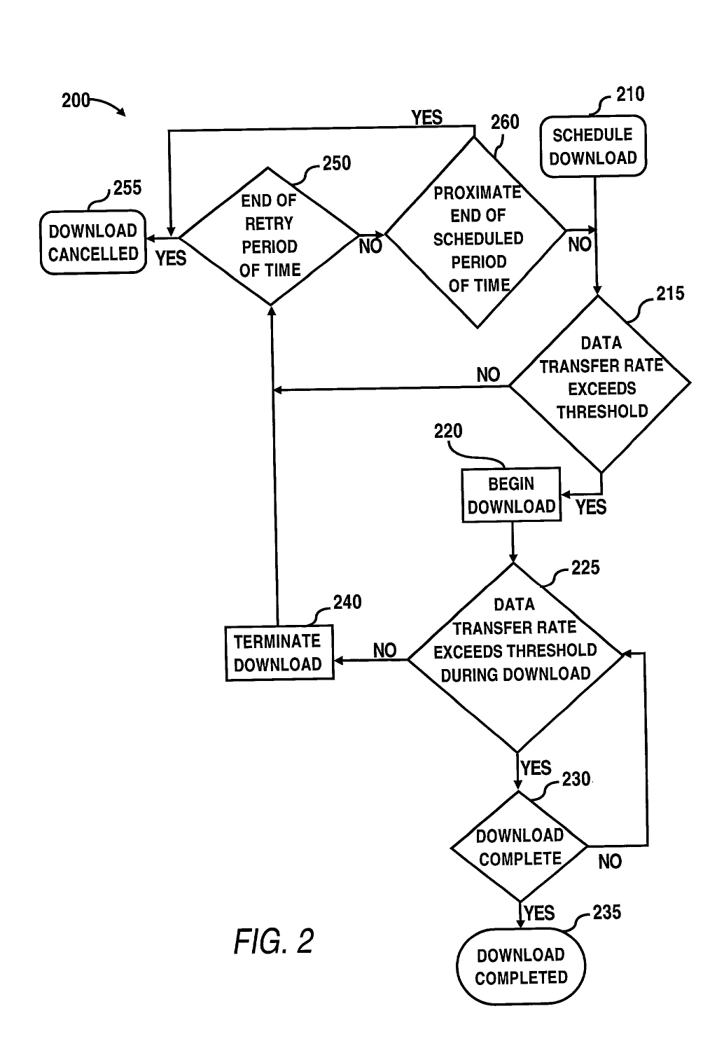

FIG. 2 illustrates an exemplary flow diagram of a method 200 for performing a download, according to an exemplary embodiment of the present invention. The steps shown in FIG. 2 are described with respect to system 100, shown in FIG. 1, for purposes of illustration. It will be apparent to one of ordinary skill in the art that the same principles are equally applicable to, and can be implemented in, any system that transfers information from one location to another, and that any such variation would be within such modifications that do not depart from the true spirit and scope of the present invention. Additionally, method 200 is described as being performed by the client. However, it will be apparent to one of ordinary skill in the art that the steps in method 200 may also be performed by the server.

In step 210, server 110 schedules a period of time (e.g., 00:00 to 04:00) for client 120 to download one or more files from server 110. The scheduled download, for example, may be in response to a previous request from client 120 for a file from server 110.

In step 215, client 120 compares a data transfer rate of the connection between server 110 and client 120 to a predetermined threshold at the beginning of the scheduled period of time (e.g., at 00:00). Server 110 may have previously notified client 120 of the scheduled period of time (e.g., shortly after server 110 assigns the scheduled period of time to client 120), or server 110 may notify client 120 at or just prior to the beginning of the scheduled period of time.

If the data transfer rate does not exceed a predetermined threshold in step 215, client 120 determines whether a retry period of time has ended (step 250). For example, the data transfer rate may be re-measured and re-compared to the predetermined threshold if the data transfer rate is below the predetermined threshold in step 215. Re-measuring and re-comparing may be performed periodically (e.g., every five minutes) if the retry period has not ended. The retry period of time (e.g., one hour) is a period of time beginning from an instance in time when client 120 first determines that the data transfer rate is below the predetermined threshold. By implementing a retry period of time, a client may be prevented from continually attempting to perform a download throughout the entire scheduled period of time.

If the retry period of time has not ended in step 250, client 120 determines whether a proximate end of the scheduled period of time has occurred (step 260). The proximate end is an instance in time that is before the end of the scheduled period of time (e.g., one hour prior to the end of the scheduled period of time). The proximate end may generally be determined, such that a download is prevented from beginning late in the scheduled period of time and continuing past the scheduled period of time. If the proximate end has occurred and the data transfer rate is still not greater than the predetermined threshold, the download is cancelled and/or rescheduled (step 255). If the proximate end has not occurred in step 260, the data transfer rate may be re-measured and re-compared to the predetermined threshold in step 215. It will be apparent to one of ordinary skill in the art that the length of the intervals between the periodic comparisons, the length of the retry period of time and the proximate end may vary for different networks and may be based network configuration, network traffic, and the like.

If the data transfer rate exceeds the predetermined threshold in step 215, client 120 begins a download from server 110 (step 220). For example, at midnight or shortly thereafter, client 120 may send a message to server 110 requesting server 110 to transmit the requested file(s). Server 110 may then transmit the requested file(s) to client 120 in response to the message. Alternatively, at midnight or shortly thereafter, server 110 may automatically began transmitting the requested file(s) to client 120.

In steps 225-235, the data transfer rate is periodically compared to the predetermined threshold during the download until the download is completed (step 235) or until the data transfer does not exceed the predetermined threshold.

If the data transfer rate does not exceed the predetermined threshold in step 225, the download is terminated in step 240. Then, client 120 determines whether the retry period of time has ended (step 250). If the retry period of time has ended, the download is cancelled and/or rescheduled (step 255). If the retry period of time has not ended, client 120 determines whether a proximate end of the scheduled period of time has occurred (step 260). If the proximate end has occurred and the data transfer rate still does not exceed the predetermined threshold, the download is cancelled and/or rescheduled (step 255). If the proximate end has not occurred in step 260, the data transfer rate may be re-measured and re-compared, to the predetermined threshold in step 215. Re-measuring and re-comparing may be performed periodically, if the retry period has not ended and the proximate end has not occurred.

In step 225, if the data transfer rate exceeds the predetermined threshold, client 120 determines whether the download is complete (step 230). If the download is not complete, the comparison in step 225 may be periodically or continually performed until the data transfer rate does not exceed the predetermined threshold or until the download is complete.

Method 200 has been described with respect to the client performing many of the steps, such as measuring the data transfer rate, comparing the data transfer rate to the predetermined threshold, detecting the proximate end of the scheduled period of time, detecting the end of the retry period of time and terminating/canceling the download. However, it will be apparent to one of ordinary skill in the art that the server may perform these steps, instead of the client. For example, in steps 215 and 225, the server may compare the data transfer rate to the predetermined threshold, and the server may detect the end of the retry period and the proximate end in steps 250 and 260. Also, the server may terminate and/or cancel the download in steps 240 and 255 when necessary. When either the server or the client terminates the download, the other end of the download may detect the termination and stop transmission/reception. Also, when a download is cancelled during the download, the next download may continue the transmission of the information without retransmitting information already downloaded.

The method shown in FIG. 2 and described above may be performed by a computer program. The computer program may exist in a variety of forms both active and inactive.

For example, the computer program may exist as software comprised of program instructions or statements in source code, object code, executable code or other formats;

firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes and the like. Exemplary computer readable signals, whether modulated using a carrier or not, are signals that a computer system hosting or running the computer program can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While this invention has been described in conjunction with the specific embodiments thereof, it is evident that many alternatives, modifications and variations will be apparent to those skilled in the art. These changes may be made without departing from the spirit and scope of the invention.

What is claimed is:

1. A method of transmitting information from a first device to a second device, the method comprising steps of:
comparing a data transfer rate to a predetermined threshold, said data transfer rate being related to the rate of transmission of information from said first device to said second device;
transmitting information from said first device during a scheduled period of time in response to said data transfer rate exceeding said predetermined threshold; and
preventing a transmission of said information at a beginning of said scheduled period of time in response to said data transfer rate not exceeding said predetermined threshold.

2. The method of claim 1, wherein said step of comparing a data transfer rate to a predetermined threshold further comprises steps of:
determining whether a retry period of time has ended in response to said data transfer rate being below said predetermined threshold;
canceling said transmission of information during said scheduled period of time in response to said retry period of time ending; and
comparing a re-measured data transfer rate to said predetermined threshold in response to said retry period of time not ending.

3. The method of claim 2, wherein said step of comparing a data transfer rate to a predetermined threshold further comprises steps of:
determining whether a proximate end to said scheduled period of time has occurred in response to said retry period of time continuing; said proximate end being an instance in time prior to an end of said scheduled period of time, such that a transmission beginning at the proximate end completes prior to the end of said scheduled period of time;
canceling said transmission of information during said scheduled period of time in response to an occurrence of said proximate end; and
performing said step of comparing said re-measured data transfer rate to said predetermined threshold in response to said proximate end to said scheduled period of time not occurring.

4. The method of claim 3, wherein said step of transmitting information from said first device further comprises a step of transmitting said information from said first device during said scheduled period of time in response to said re-measured data transfer rate exceeding said predetermined threshold.

5. The method of claim 1, wherein said step of transmitting information from said first device further comprises steps of:
comparing a data transfer rate of said transmitting information to said predetermined threshold; and
terminating said transmission of information in response to said data transfer rate not exceeding said predetermined threshold.

6. The method of claim 5, wherein said step of transmitting information from said first device further comprises steps of:
determining whether a retry period of time has ended in response to said data transfer rate not exceeding said predetermined threshold;
canceling said transmission of information during said scheduled period of time in response to said retry period of time ending; and
comparing a re-measured data transfer rate to said predetermined threshold in response to said proximate end to said scheduled period of time not occurring.

7. The method of claim 6, wherein said step of transmitting information from said first device further comprises a step of transmitting said information from said first device during said scheduled period of time in response to said re-measured data transfer rate exceeding said predetermined threshold.

8. The method of claim 1, wherein said step of comparing is performed by said first device.

9. The method of claim 1, wherein said step of comparing is performed by said second device.

10. The method of claim 1, further comprising a step of requesting information from said first device prior to said step of comparing, wherein said information includes said scheduled period of time.

11. A system comprising:
a first device; and
a second device connected to said first device through a network, wherein said first device is operable to transmit information to said second device at a scheduled period of time when a data transfer rate for a network connection in said network between said first device and said second device exceeds a predetermined threshold.

12. The system of claim 11, wherein said first device is operable to withhold transmission of information to said second device at a beginning of said scheduled period of time in response to said data transfer rate not exceeding said predetermined threshold.

13. The system of claim 12, wherein said first device is operable to terminate transmission of said information after said transmission is started in response to said data transfer rate for said connection not exceeding said predetermined threshold during said transmission.

14. The system of claim 13, wherein said first device is a server in said network and second device is a client in said network.

15. The system of claim 14, wherein said first device is operable to compare said data transfer rate to said predetermined threshold.

16. The system of claim 14, wherein said second device is operable to compare said data transfer rate to said predetermined threshold.

17. A computer readable medium on which is embedded a program, the program performing a method of transmitting information from a first device to a second device, the method comprising steps of:
comparing a data transfer rate to a predetermined threshold, said data transfer rate being related to the rate of transmission of information from said first device to said second device;
transmitting information from said first device during a scheduled period of time in response to said data transfer rate exceeding said predetermined threshold; and
preventing a transmission of said information at a beginning of said scheduled period of time in response to said data transfer rate not exceeding said predetermined threshold.

18. The computer readable medium of claim 17, wherein said step of comparing a data transfer rate to a predetermined threshold further comprises steps of:
determining whether a retry period of time has ended in response to said data transfer rate being below said predetermined threshold; and
determining whether a proximate end to said scheduled period of time has occurred in response to said retry period of time not ending; said proximate end being an instance in time prior to an end of said scheduled period of time.

19. The computer readable medium of claim 18, wherein said step of comparing a data transfer rate to a predetermined threshold further comprises a step of:
canceling said transmission of information during said scheduled period of time in response to an occurrence of said proximate end or an occurrence of said retry period of time.

20. The computer readable medium of claim 19, wherein said step of comparing is performed during said transmission of information and said step of preventing further comprises a step of:
terminating said transmission of said information at a beginning of said scheduled period of time in response to said data transfer rate not exceeding said predetermined threshold.

21. A network node connected to a network, said network node being operable to:
transmit information at a scheduled period of time on a communication path in said network when a data transfer rate for said communication path exceeds a predetermined threshold;
prevent transmission of said information in response to said data transfer rate not exceeding said predetermined threshold;
determine whether a retry period of time has ended in response to said data transfer rate being below said predetermined threshold;
cancel said transmission of information during said scheduled period of time in response to said retry period of time ending; and
compare a re-measured data transfer rate to said predetermined threshold in response to said retry period of time not ending.

22. The network node of claim 21, wherein said network node is further operable to:
determine whether a proximate end to said scheduled period of time has occurred in response to said retry period of time continuing; said proximate end being an instance in time prior to an end of said scheduled period of time, such that a transmission beginning at the proximate end completes prior to the end of said scheduled period of time;
cancel said transmission of information during said scheduled period of time in response to an occurrence of said proximate end; and
perform said comparison of said re-measured data transfer rate to said predetermined threshold in response to said proximate end to said scheduled period of time not occurring.

23. The network node of claim 22, wherein said network node is further operable to transmit said information during said scheduled period of time in response to said re-measured data transfer rate exceeding said predetermined threshold.

24. The network node of claim 21, wherein said network node transmits said information and said network node is further operable to:
compare a data transfer rate of said transmitting information to said predetermined threshold; and
terminate said transmission of information in response to said data transfer rate not exceeding said predetermined threshold.

25. The network node of claim 21, wherein said network node includes at least one server.

26. The network node of claim 25, wherein said network node is operable to be connected to at least one client via said network and transmit information at a scheduled period of time on said communication path to said at least one client when said data transfer rate for said communication path exceeds said predetermined threshold.
